(19) United States
(12) Patent Application Publication
(10) Pub. No.: US 2026/0287165 A1
(43) Pub. Date: Sep. 24, 2026

(54) BACKPACK WITH AN INTEGRATED LIGHTING MOUNT APPARATUS

(71) Applicants: Cam With A Cam LLC, Los Angeles, CA (US); Axton Advisors LLC, Los Angeles, CA (US)

(72) Inventors: Cameron Venti, Los Angeles, CA (US); Sergio Moya, Los Angeles, CA (US)

(21) Appl. No.: 19/084,588

(22) Filed: Mar. 19, 2025

(51) Int. Cl. F21V 33/00; A45F 3/04; F21V 21/116; F21V 21/22; A45F 3/00

(52) U.S. Cl. CPC F21V 33/0004; A45F 3/04; F21V 21/116; F21V 21/22; A45F 2003/003; A45F 2003/045

(57) ABSTRACT

A backpack with an integrated lighting mount apparatus or system, wherein the integrated lighting mount apparatus or system is securely attached to a dedicated compartment of the backpack. The integrated lighting mount apparatus may include one or more extending rods or poles that extend through holes in the dedicated compartment. The mounting rod of each of the extending rods is configured to engage with a piece of lighting equipment. The other backpack compartments may be used to store various equipment and devices, including, but not limited to, those used for photography or for portably lighting an area in a hands-free manner. The extending rods may have adjustable connectors that allow the mounting rod to slidingly and telescopically move (or move in some other extending manner) vertically up and down, and then be releaseably locked into a desired position.

### FIELD OF USE

The present disclosure is generally directed modified backpacks, and more specifically, to backpacks modified to include a lightweight structure protruding from the backpack to which lighting accessories may be attached.

### BACKGROUND

There are numerous types of photography accessories, including lighting mounts. Existing lighting mounts and mount systems are either immobile or must be held by hand, requiring the photographer to dedicate attention and at least one hand to manipulating lighting angles. Due to the expensive and delicate nature of camera equipment, most photographers also have a camera bag to store their costly and fragile equipment. Current systems and devices require photographers to take off their camera bag, unpack any equipment, including lighting systems, and set up their lighting system, before being ready to take photos. Even once this arduous and time-consuming process is complete, the lighting system will either be immobile or require the photographer to be manipulated by hand. Thus, what is needed is a lighting mount system or apparatus that provides for the mounting of the lighting equipment to a user’s body that leaves the users hands free, while also providing portable storage for the user’s lighting and camera equipment.

### SUMMARY

To minimize the limitations in the prior art and to minimize other limitations that will become apparent upon reading and understanding the present specification, the present disclosure discloses new and useful devices, systems, and methods related to backpacks with integrated lighting mount apparatus.

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

Various embodiments of the present disclosure may be directed to backpack and lighting mount systems and devices that allow a user to illuminate a subject in a mobile manner without the use of the user’s hands. The backpack and lighting mount apparatus may comprise a backpack portion and a lighting mount portion, wherein the lighting mount portion is affixed to an interior surface of the backpack portion. The lighting mount portion may preferably comprise one or more telescoping mounting rods, configured to extend from within the backpack portion through a rod aperture in the surface of the backpack portion to a height above the top of the backpack portion, and a connection element. The end of each of the one or more telescoping rods may be affixed with a lighting equipment connector configured to allow a user to attach standard lighting equipment, including, but not limited to, reflectors, diffusers, light bulbs, or combinations thereof. The one or more mounting rods may be affixed with adjustable connectors, allowing the user to affix the one or more mounting rods at a user determined height. The connection element may be configured to join the rods into a single, rigid structure, as well as to provide a more stable connection to the backpack portion’s surface. In this embodiment, a user may extend the one or more mounting rods, affix the one or more mounting rods in the extended position using the adjustable connectors, connect their lighting equipment to the lighting equipment connection, and use shoulder straps affixed to the backpack portion to mount the backpack and integrated lighting mount apparatus to their body. In this configuration, a user may be able to illuminate a photograph subject from an elevated angle without the use of their hands, and while remaining mobile to shift the angle of the lighting.

In alternative embodiments, the integrated lighting mount apparatus may comprise a single mounting rod. The mounting rod may be telescoping, configured to extend from within the backpack portion through a rod aperture in the surface of the backpack portion to a height above the backpack portion. The end of the mounting rod may be affixed with a lighting equipment connector configured to allow a user to attach standard lighting equipment, including, but not limited to, reflectors, diffusers, light bulbs, or combinations thereof. The mounting rod may be affixed with an adjustable connector, allowing the user to affix the mounting rod at a user determined height. In this embodiment, a user may extend the mounting rod, affix the mounting rod in the extended position using the adjustable connector, connect their lighting equipment to the lighting equipment connection, and use shoulder straps affixed to the backpack portion to mount the backpack with an integrated lighting mount apparatus to their body. In this configuration, a user may be able to illuminate a photograph subject from an elevated angle without the use of their hands, and while remaining mobile to shift the angle of the lighting.

The integrated lighting mount apparatus or system of the present disclosure may be comprised of metal, plastic, wood, carbon fiber or other composite materials, and combinations thereof. The main frame of the integrated lighting mount apparatus may be a unitary apparatus or device, or it may be composed of an apparatus with multiple parts.

The backpack with an integrated lighting mount apparatus of the present disclosure is novel because it enables a user to illuminate a subject without the continual use of hands and allows the source of that illumination to remain mobile. By incorporating the lighting mount system or apparatus into a portion of a backpack, the user may carry their equipment between locations using the same device that allows them to mount lighting equipment for mobile illumination.

One embodiment may be a backpack with an integrated lighting mount apparatus may comprise: a backpack that includes at least one integrated lighting mount apparatus compartment, which comprises two mounting rod openings; a main storage compartment; two shoulder straps; and an integrated lighting mount apparatus, wherein the integrated lighting mount apparatus may comprises: two sets of extending rods, each of which comprises a vertical rod, a mounting rod, and an adjustable connector; wherein each of the two mounting rods may be configured to extend through one of the two mounting rod openings; wherein each of the two vertical rods may be securely affixed to an interior of the integrated lighting mount apparatus compartment by a rod securing device; wherein each of the two mounting rods has a lighting equipment connector, which may be configured to removeably and matingly engage with a piece of lighting equipment; and wherein the at least one adjustable connector may be configured to securely but releaseably lock the vertical rod and at least one mounting rod into a retracted position, an extended position, and one or more partially extended positions. The device may further comprise one or more additional storage compartments and/or a hip belt. Each of the at least one adjustable connectors may have a release mechanism that when closed prevents the vertical rod and the mounting rod from moving in an extending manner with respect to each other, and that when open allows the vertical rod and the mounting rod to move in an extending manner with respect to each other. The integrated lighting mount apparatus compartment further comprises an equipment loop and wherein the integrated lighting mount apparatus further comprises a counterweight. Alternatively, the two vertical rods may be connected to each other as a unitary base device. The unitary base device may be substantially a rectangular “U” shape or a “V” shape. In another embodiment, the integrated lighting mount apparatus further comprises two corner connectors and a base rod; the base rod may be securely affixed to an interior of the integrated lighting mount apparatus compartment by a base rod securing device; each of the two corner connectors attaches to opposite sides of the base rod on one end and to one of the two vertical rods on the other end, such that the integrated lighting mount apparatus substantially forms a rectangular “U” shape. The two vertical rods of the integrated lighting mount apparatus may be substantially parallel to each other and substantially perpendicular to the base rod. The two vertical rods, the base rod, the two corner connectors, the two rod straps, and the base rod strap, and the two adjustable connectors may be substantially contained and enclosed within the integrated lighting mount apparatus compartment when the integrated lighting mount apparatus compartment is closed.

Another embodiment may be a backpack with an integrated lighting mount apparatus comprising: a backpack that includes at least one integrated lighting mount apparatus compartment, which comprises at least one mounting rod opening, one or more additional storage compartments, at least two shoulder straps; and an integrated lighting mount apparatus, wherein the integrated lighting mount apparatus comprises: at least one set of extending rods, each of which has at least one adjustable connector; each set of extending rods comprises a vertical rod and at least one mounting rod; the mounting rod may be configured to extend through the at least one mounting rod opening; each vertical rod may be securely affixed to an interior of the integrated lighting mount apparatus compartment by a rod securing device; the mounting rod may have a lighting equipment connector, which may be configured to removeably and matingly engage with a piece of lighting equipment; and the adjustable connector may be configured to securely but releaseably lock the vertical rod and at least one mounting rod into a retracted position, an extended position, and one or more partially extended positions. The one or more additional storage compartments comprises a main storage compartment and one or more side pockets. The backpack may further comprise a hip belt. Each of the adjustable connectors may have a release mechanism that when closed prevents the vertical rod from moving in an extending manner with respect to the mounting rod, and that when open allows the vertical rod to move in an extending manner with respect to the mounting rod. The integrated lighting mount apparatus compartment may further comprise an equipment loop and a counterweight. There may be two sets of extending rods. The integrated lighting mount apparatus may further comprise two conner connectors and a base rod, which may be securely affixed to an interior of the integrated lighting mount apparatus compartment by a base rod securing device; each of the two corner connectors attaches to opposite sides of the base rod on one end and to one of the two vertical rods on the other end, such that the integrated lighting mount apparatus substantially forms a rectangular “U” shape. The two vertical rods of the integrated lighting mount apparatus may be substantially parallel to each other and substantially perpendicular to the base rod. The two vertical rods, the base rod, the two corner connectors, the two rod straps, and the base rod strap, and the two adjustable connectors may be substantially contained and enclosed within the integrated lighting mount apparatus compartment when the integrated lighting mount apparatus compartment is closed. In some embodiments the mounting rods are also substantially enclosed when retracted.

Another embodiment may be a backpack with an integrated lighting mount apparatus comprising: a backpack comprising: an integrated lighting mount apparatus compartment, which may comprise two mounting rod openings; a main storage compartment; two shoulder straps; and an integrated lighting mount apparatus that comprises a “V” shaped rod that has two diagonally vertical ends, two mounting rods, and two adjustable connectors; each of the two diagonally vertical ends extendingly and matingly engage with one of the two mounting rods; each of the two mounting rods may be configured to extend through one of the two mounting rod openings; the integrated lighting mount apparatus may be securely affixed to an interior of the integrated lighting mount apparatus compartment by one or more securing devices; each of the two mounting rods may have a lighting equipment connector, which may be configured to removeably and matingly engage with a piece of lighting equipment; and each of the two adjustable connectors may be configured to securely but releaseably lock one of the two diagonally vertical ends and one of the two mounting rods into a retracted position, an extended position, and one or more partially extended positions. The “V” shaped rod may be constructed from an aluminum pole that has been bent into the “V” shape.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps, which are illustrated. When the same numeral appears in different drawings, it refers to the same or like components or steps.

FIG. 1 is an illustration of a front and top perspective view of one embodiment of a backpack with an integrated lighting mount apparatus with the mounting rods at least partially extended.

FIG. 2 is an illustration of a front view of one embodiment of a backpack with an integrated lighting mount apparatus with the lighting mount apparatus compartment exposed, and the mounting rods retracted.

FIG. 3 is an illustration of a front view of one embodiment of a backpack with an integrated lighting mount apparatus with the lighting mount apparatus compartment exposed, and the mounting rods at least partially extended with lighting equipment mounted.

FIG. 4 is an illustration of a front view of another embodiment of a backpack with an integrated lighting mount apparatus with the lighting mount apparatus compartment exposed, and the mounting rods at least partially extended.

FIG. 5 is an illustration of a front view of another embodiment of a backpack with an integrated lighting mount apparatus with the lighting mount apparatus compartment exposed, and the mounting rod is at least partially extended.

FIG. 6 is an illustration of a rear and top perspective view of one embodiment of a backpack with an integrated lighting mount apparatus with the mounting rods retracted.

FIG. 7 is an illustration of a front view of another embodiment of a backpack with an integrated lighting mount apparatus with the lighting mount apparatus compartment exposed, and the mounting rods retracted and entirely enclosed within the backpack.

FIG. 8 is an illustration of a front view of another embodiment of a backpack with an integrated lighting mount apparatus with the lighting mount apparatus compartment exposed, and the mounting rod is at least partially extended from a side pocket of the backpack.

### DETAILED DESCRIPTION OF THE ILLUSTRATIVE EMBODIMENTS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screenshot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods, devices, and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods, devices, and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods, devices, and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001 - 10% from the indicated number or range of numbers.

In the following description, certain terminology is used to describe certain features of the various embodiments of the device, method, and/or system. For example, as used herein, the term “lighting equipment” or “piece of lighting equipment” refers to devices and equipment used by persons, such as photographers to manipulate or alter the light or lighting of the environment of a photographic subject, including, but not limited to, lighting systems, reflectors, diffusers, light bulbs, flash bulbs, lights, flashlights, lighting fixtures, equivalents thereof, and the like. In addition to photographers, the device of the present disclosure can be used by a variety of users. A backpack with a lighting system can be used to hike, explore, and do other night activities. The device of the present discloser may be used by vloggers, mobile filmmakers, and outdoor work, such as construction, emergency response, and the like.

As used herein the term “telescoping pole lock” and/or “adjustable connectors” refers to any releasable lock mechanism that positions two concentric telescoping poles into one or more extended positions and a retracted position, such as an adjustable clamp, a twist clamp, a twist lock, a lever lock, a flip lock, a screw tab lock, a tilt lock and knob, a friction lock, ball and detent style locks, spring locks, thumb locks, magnet locks, equivalents thereof, and the like.

As used herein the term “extending rods” or “extending poles” refers to telescopic rods or poles, articulated arms, foldable extensions, and the like, which are configured to allow a compact system to extend or get longer.

As used herein the term “securing device(s)” or “rod securing device(s)” may be any mechanism, device, or system that is used to secure a pole or rod to an interior of a backpack compartment, including, but not limited to: belts, straps, clamps, chains, clips, toggles, bolts, screws, adhesives, sewing (threads), ultrasonic welding, brackets, hook and loop (Velcro®), magnets, heat press, equivalents thereof, and the like.

As used herein the term “vertical rod” may be a rod, pole, or arm that serves as a portion of a set of extending rods. Although in many cases the vertical rod is positioned vertically, it may also be positioned diagonally or horizontally, as required or as relative to the base.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details.

Those skilled in the art will recognize that many modifications may be made to the disclosed configurations without departing from the scope of the disclosed embodiments.

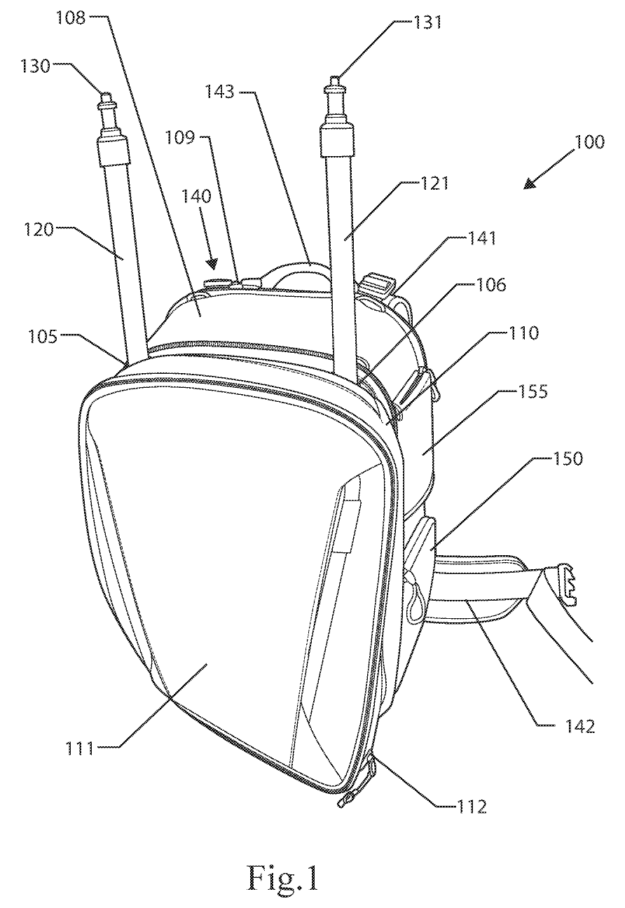

FIG. 1 is an illustration of a front and top perspective view of one embodiment of a backpack with an integrated lighting mount apparatus with the mounting rods at least partially extended. As shown in FIG. 1, backpack 100 may have an integrated lighting mount apparatus and may comprise mounting rod openings 105, 106, main storage compartment 108, main storage compartment closure 109, which is typically a zipper, lighting mount apparatus compartment 110, lighting mount apparatus compartment cover 111, lighting mount apparatus compartment closure 112, which is typically a zipper, mounting rods 120, 121, lighting equipment connector 130, 131, shoulder straps 140, 141, handle 143, hip belt 142, and side pockets 150, 155. Main storage compartment 108 and side pockets 150, 155 may be standard backpack compartments that are used to hold a variety of goods. In one embodiment, main storage compartment 108 and side pockets 150, 155 may be used to store anything the user needs, such as, by way of a non-limiting example, various photography and camera equipment, including cameras, lighting equipment, straps, tripods, glass/electronic cleaning supplies, color correction cards, flash, lights, reflectors, stands, backdrops, props, monitors, computers, external hard drives, editing software, softboxes, flashpoint monolights, glow softboxes, extra mounting equipment/brackets, instructions manuals, flashpoints, equivalents thereof, and the like. Main storage compartment 108 and side pockets 150, 155 may be configured to specifically hold various pieces of photography, lighting, and camera equipment.

In other embodiments, backpack 100 may have other features not shown in FIG. 1, such as a top pocket, a top cover, a sternum strap, cargo nets, bottle holders, equivalents thereof, and the like. Preferably, backpack 100, other than mounting rods 120, 121 coming out of mounting rod openings 105, 106, may have the look, function, and materials of a standard backpack or a photography/camera backpack. Mounting rod openings 105, 106 may be apertures, holes, slits, slots, slashes, grommets, equivalents thereof, and the like, which preferably allow mounting rods 120, 121 to protrude through and extend out of backpack 100. Backpack 100 preferably has at least one storage compartment other than integrated lighting mount apparatus compartment 110. More preferred is that backpack 100 may have several compartments, such as main storage compartment 108 and side pockets 150, 155 so that it looks and functions like an ordinary backpack or camera backpack.

FIG. 1 shows that mounting rods 120, 121 are at least partially extended from lighting mount apparatus compartment 110. Mounting rods 120, 121 may be made from plastic, wood, metal, or composite materials (preferably aluminum or carbon fiber), may end with lighting equipment connectors 130, 131. Lighting equipment connectors 130, 131 may be plastic or metal, such as steel or aluminum, and may be configured to be compatible with standard lighting equipment and may have standard attachment specifications. As shown in FIG. 1, lighting equipment connectors 130, 131 may have a one quarter inch, twenty thread screw connection. In a preferred embodiment, lighting equipment connectors 130131 may be precision machined to ensure compatibility with commercially available lighting equipment.

Preferably, a user may extend mounting rods 120, 121 and then mount on to them a piece of lighting equipment. The user can then don backpack 100 and position the mounted lights/lighting equipment to light the subject of a photography session or be used as a portable light for hands-free use for any purpose. In this manner, the user can effectively and precisely direct light in a specific direction by twisting or turning their body.

As shown, preferably, closures 109, 112 may be zippers that allow compartments 108, 110 to be opened and closed, just as done in an ordinary backpack. Other closures may be used so long as the backpack compartments can be accessed and substantially closed again.

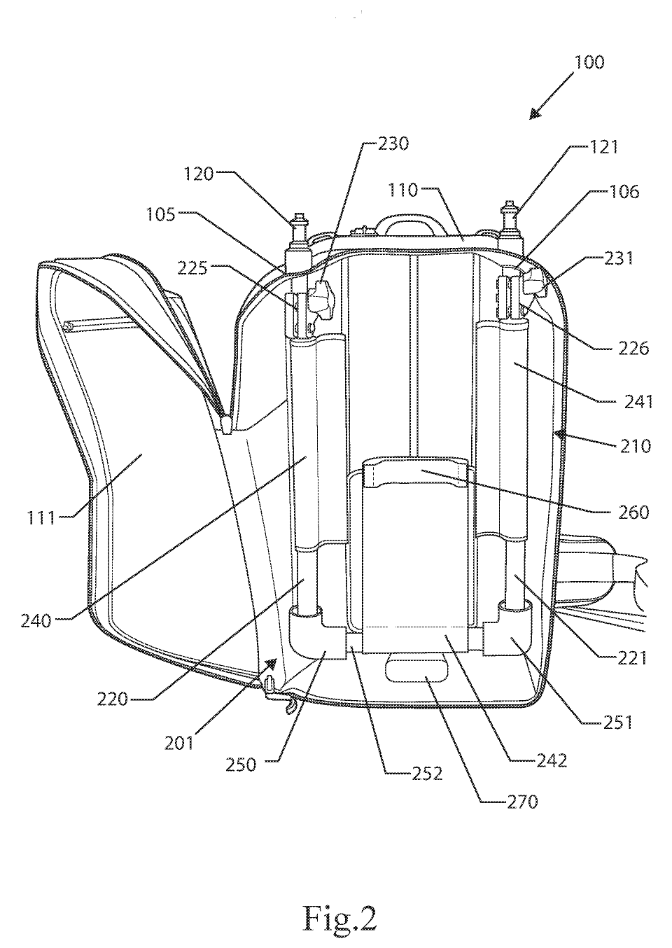

FIG. 2 is an illustration of a front view of one embodiment of a backpack with an integrated lighting mount apparatus with the lighting mount apparatus compartment exposed, and the mounting rods retracted. As shown in FIG. 2, backpack 100 may comprise mounting rod openings 105, 106, lighting mount apparatus compartment 110, which has interior 210, and lighting mount apparatus compartment cover 111, which has been opened to expose interior 210 of compartment 110, which at least partially or mostly contains and/or supports integrated lighting mount apparatus 201, which comprises mounting rods 120, 121, vertical rods 220, 221, corner connectors 250, 251, base rod 252, vertical rod securing devices 240, 241, base rod securing device 242, adjustable connectors 225, 226, release mechanisms 230, 231, and counterweight 270. FIG. 2 shows mounting rods 120, 121 as retracted into vertical rods 220, 221, such that the profile and visibility of integrated lighting mount apparatus 201 is reduced and backpack 100 appears substantially similar to a normal backpack or camera backpack. Preferably, mounting rods 120, 121 protrude through mounting rod openings 105, 106, even when fully retracted, but some embodiments have mounting rods 120, 121 entirely enclosed with interior 210 when retracted.

Preferably, mounting rods 120, 121, vertical rods 220, 221, and base rod 252 are made substantially of aluminum or carbon fiber to increase strength and decrease weight. Corner connectors 250, 251 may be made of any material, including polyvinyl chloride (PVC). Preferably, mounting rods 120, 121 and vertical rods 220, 221 are hollow poles that connect telescopically, such that mounting rods 120, 121, slidably move into or around vertical rods 220, 221. Although vertical rods 220, 221 are shown as being substantially vertical and parallel to each other, they may be angled obtusely or acutely with respect to each other. Preferably, vertical rods 220, 221 are substantially vertical in relation to base rod 252 and/or the bottom of backpack 100, but they may be at any angle. Preferably vertical rods 220, 221 are parallel to each other, or at an acute angle relative to each other, such that mounting rods 120, 121 extend substantially upward in a parallel manner or upward and away from each other.

Although only two sets of two telescoping rods or poles are shown in FIG. 2, integrated lighting mount apparatus 201 may comprise one set of telescoping rods or poles, three sets of telescoping rods or poles, or more, depending on how many lighting mounts are desired. Further, each set of telescoping rods or poles may comprise three or more total telescoping rods or poles, depending on how much height is desired. Although it is preferably to provide balance to backpack 100 by having offset, an even number, or a number of sets to provide balance, backpack 100 may have uneven or unbalanced mounting poles without deviating from the scope of the present disclosure. The telescoping rods or poles may be other configurations of extending rods or extending poles, such as foldable or articulating arms or rods.

Preferably, vertical rods 220, 221, and base rod 252 are connected via corner connectors 250, 251 such that they form a “U” or a rectangular shape, and vertical rods 220, 221 are balanced on opposite sides of interior 210 of lighting mount apparatus compartment 110. As shown in FIG. 2, a top end of vertical rods 220, 221 has adjustable connectors 225, 226, which are shown as friction clamps that are loosened or tightened, and which include release mechanisms 230, 231, which are shown as twist screws. When twist screw release mechanisms 230, 231 are loosened, mounting rods 120, 121 are configured to be slidably or telescopically moveable in and out of vertical rods 220, 221. When twist screw release mechanisms 230, 231 are tightened, mounting rods 120, 121 are configured to be held firmly in place in whatever position a user put them in, such as retracted, partially extended, or entirely extended. In this manner, a user may adjust the height of each mounting rod, as desired. Adjustable connectors 225, 226, release mechanisms 230, 231 combine to provide two telescoping pole locks.

FIG. 2 also shows equipment loop 260, which may be used to securely, safely, and/or removeably hold equipment between vertical rods 220, 221. There may be additional straps, compartments, pockets, or netting to store various devices and equipment in lighting mount apparatus compartment 110 along with integrated lighting mount apparatus 201.

Counterweight 270 may be a removeable or adjustable device or weight that can be included in order to provide downward balance to backpack 100 when mounting rods are extended and supporting the weight of lighting equipment. Counterweight 270 may be connected to interior 210, to integrated lighting mount apparatus 201, and/or to base rod securing device 242.

Although integrated lighting mount apparatus 201 is shown as comprised of several different rods and connectors that are contained within lighting mount apparatus compartment 110, integrated lighting mount apparatus 201 may be a unitary rod that is bent in substantially the same shape as shown in FIG. 2. Preferably this unitary rod would have one or more telescoping mounting rods and adjustable connectors.

FIG. 2 shows that integrated lighting mount apparatus 201 may be integrated with backpack 100 via vertical rod securing devices 240, 241 and base rod securing device 242. As shown, vertical rod securing devices 240, 241 and base rod securing device 242 may loop around vertical rods 220, 221, and base rod 252, thus securing vertical rods 220, 221, and base rod 252 to interior 210 of lighting mount apparatus compartment 110. In some embodiments, vertical rod securing devices 240, 241 and base rod securing device 242 may permanently secure integrated lighting mount apparatus 201 to interior 210 of lighting mount apparatus compartment 110. In other embodiments, vertical rod securing devices 240, 241 and base rod securing device 242 may removeably secure integrated lighting mount apparatus 201 to interior 210 of lighting mount apparatus compartment 110. As shown, vertical rod securing devices 240, 241 and base rod securing device 242 may be fabric reinforced with elastic (similar to a standard car seatbelt). In addition to being fabric, reinforced fabric, elastic, and/or leather straps, rod securing devices 240, 241 and base rod securing device 242 may be any securing device, such as clamps, clips, or an adhesive, so long as integrated lighting mount apparatus 201 is securely and integrally held in place within lighting mount apparatus compartment 110. Alternatively, integrated lighting mount apparatus 201 may be sewn directly into interior 210 of lighting mount apparatus compartment 110. Rod securing devices 240, 241 and base rod securing device 242 securely hold integrated lighting mount apparatus 201 when mounting rods 120, 121 are extended and have lighting equipment mounted.

In one embodiment the extended length of each set of telescoping rods or poles, such as mounting rods 120, 121 and vertical rods 220, 221, may extend approximately 26.5 inches, to provide optimal height for lighting coverage. When retracted, each set of telescoping rods or poles, such as mounting rods 120, 121 and vertical rods 220, 221, preferably measure approximately16 inches, ensuring compact storage substantially within backpack 100. The outer diameter of mounting rods 120, 121 may be about 5/8 inch, which strikes a balance between structural strength and portability. The horizontal base of the “U” shaped integrated lighting mount apparatus 201, preferably maintains a consistent 9-inch distance between each set of telescoping rods or poles, such as mounting rods 120, 121 and vertical rods 220, 221, to provide stability and even light/lighting distribution. Integrated lighting mount apparatus 201, preferably weighs under 1.5 pounds to minimize the impact on the portability of backpack 100. Preferably, backpack 100 is configured or designed to evenly distribute the weight of integrated lighting mount apparatus 201 and the other contents of backpack 100 by using padded shoulder straps and a lumbar support system. Preferably, the maximum weight of backpack 100 may be about 3-6 pounds. Preferably, backpack 100 with integrated lighting mount apparatus 201 may support lights or lighting equipment that each weigh about 2-5 pounds. Using a removeable counterweight, such as counterweight 270 may allow a user to mount heavier lighting equipment to mounting rods 120, 121.

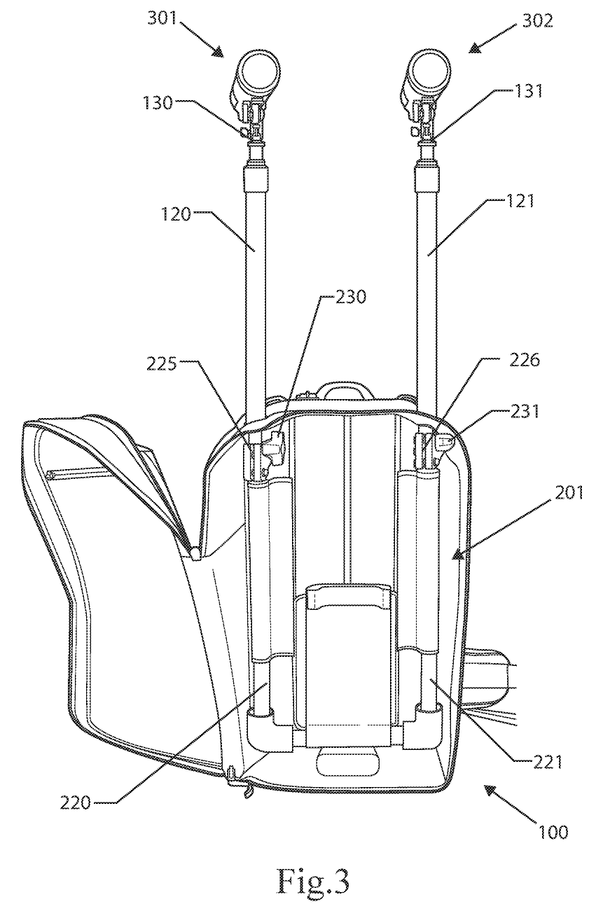

FIG. 3 is an illustration of a front view of one embodiment of a backpack with an integrated lighting mount apparatus with the lighting mount apparatus compartment exposed, and the mounting rods at least partially extended with lighting equipment mounted. As shown in FIG. 3, backpack 100 may comprise integrated lighting mount apparatus 201, which comprises mounting rods 120, 121, lighting equipment connector 130, 131, vertical rods 220, 221, adjustable connectors 225, 226, and release mechanisms 230, 231. FIG. 3 shows that mounting rods 120, 121 are extended and locked into place by adjustable connectors 225, 226, and release mechanisms 230, 231. As shown in FIG. 3, two lights 301, 302 have been mounted on lighting equipment connectors 130, 131. Preferably, the lights are adjustable so that the user may position them at the direction and angle that is desirable for lighting a photograph subject or for portably lighting, in a hands-free manner.

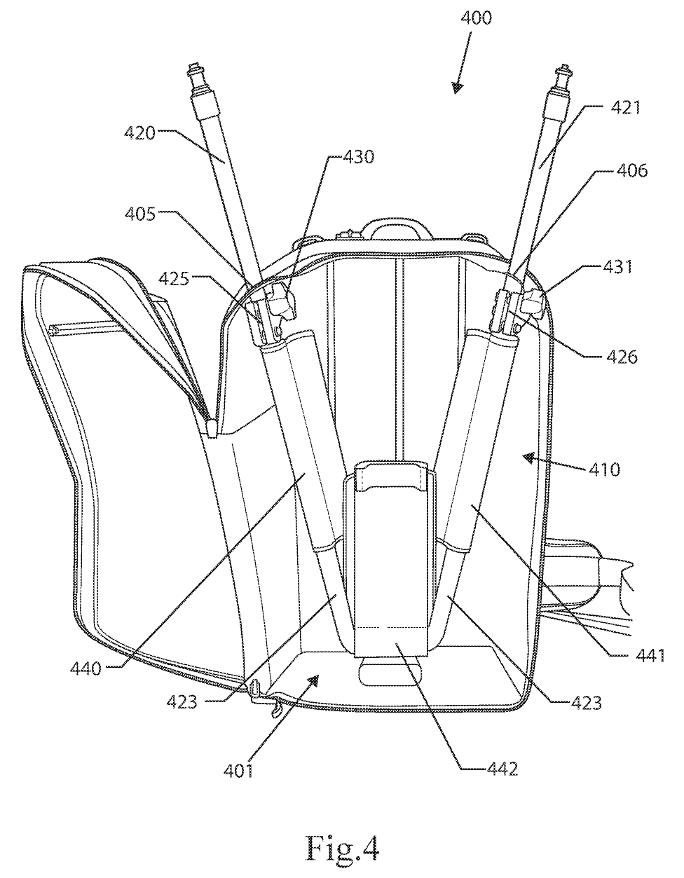

FIG. 4 is an illustration of a front view of another embodiment of a backpack with an integrated lighting mount apparatus with the lighting mount apparatus compartment exposed, and the mounting rods at least partially extended. As shown in FIG. 4, backpack 400 may comprise mounting rod openings 405, 406, lighting mount apparatus compartment 410, which has been opened to expose the interior of compartment 410, which at least partially or mostly contains and/or supports integrated lighting mount apparatus 401, which comprises mounting rods 420, 421, rod 423, diagonal rod securing devices 440, 441, base rod securing device 442, adjustable connectors 425, 426, release mechanisms 430, 431. Rod 423 may be in substantially a “V” shape and may be securely, firmly, and/or releaseably held in place within compartment 410 by diagonal rod securing devices 440, 441 and base rod securing device 442. Mounting rod openings 405, 406 may be positioned on a top of compartment 410, such that the two tops of rod 423 are aligned with openings 405, 406. This allows mounting rods 420, 421 to pass through openings 405, 406 and telescopically engage with rod 423. Adjustable connectors 425, 426, release mechanisms 430, 431, are configured to secure and release mounting rods 420, 421 into extended and retracted positions. The “V” shape of rod 423 allows lighting equipment to be operatively balanced on mounting rods 420, 421.

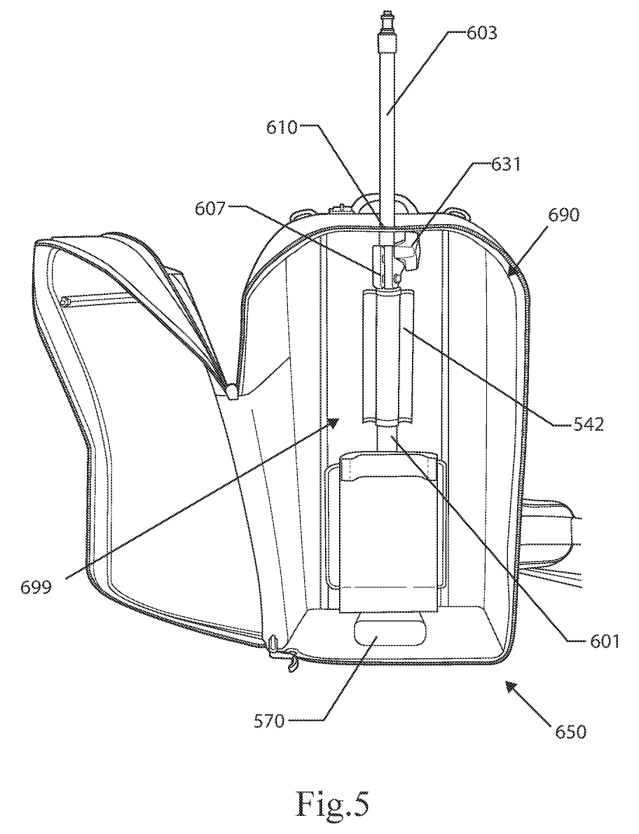

FIG. 5 is an illustration of a front view of another embodiment of a backpack with an integrated lighting mount apparatus with the lighting mount apparatus compartment exposed, and the mounting rod is at least partially extended. As shown in FIG. 5, backpack 650 may comprise mounting rod opening 610, lighting mount apparatus compartment 690, which at least partially or mostly contains or supports integrated lighting mount apparatus 699, which comprises mounting rod 603, rod 601, bottom rod securing device 542, counterweight 570, adjustable connector 607, release mechanism 631. FIG. 5 shows that integrated lighting mount apparatus 699 may have a single telescoping pole that is centered within lighting mount apparatus compartment 690.

In one embodiment, there may be two lighting mount apparatus compartments, which are each similar to compartment 690, but which are positioned on the sides of the backpack. In this manner the user may balance the lighting equipment on opposite side compartments. Bottom rod securing device 542 is shown as a fabric strap reinforced with elastic, but it may be any type of securing device, such as being directly sewn to compartment 690, clamp, clip, adhesive, ultrasonic welding, equivalents thereof, and the like. Optionally, counterweight 570 may be included to balance heavier lighting equipment loads that are mounted to the end of mounting rod 601.

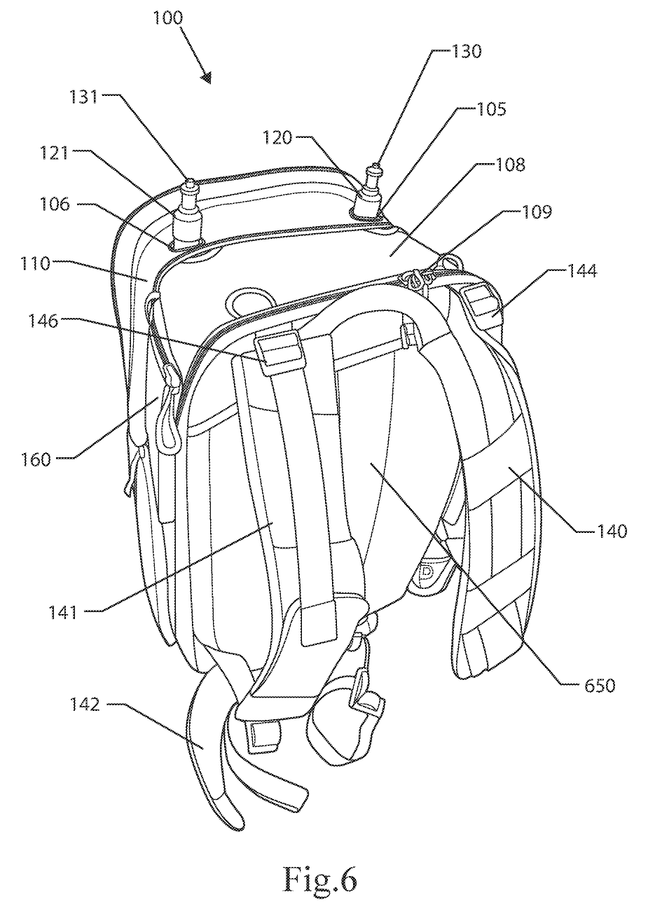

FIG. 6 is an illustration of a rear and top perspective view of one embodiment of a backpack and lighting mount apparatus with the mounting rods retracted. As shown in FIG. 6, backpack 100 may have an integrated lighting mount apparatus and may comprise mounting rod openings 105, 106, main storage compartment 108, main storage compartment closure 109, which is typically a zipper, lighting mount apparatus compartment 110, mounting rods 120, 121, lighting equipment connector 130, 131, shoulder straps 140, 141, which are preferably padded and ergonomically shaped, hip belt 142, shoulder strap adjustments 143, 144, side pocket 160, and back panel 650. FIG. 6 shows the top of mounting rods 120, 121, which are at least partially retracted, protruding out through mounting rod openings 105, 106. In this embodiment, a user is able to retract mounting rods 120, 121 and keep any mounted lighting equipment in a mounted position if desired. Back panel 650 is preferably a padded panel that cushions the load of backpack 100 and provides comfort to the wearer. Hip belt 142, which is preferably adjustable and padded, provides side and lumbar support, and allows the user to balance the load of backpack 100 more easily. Although not shown, shoulder straps 140, 141 may include a sternum strap to further provide load support and balance.

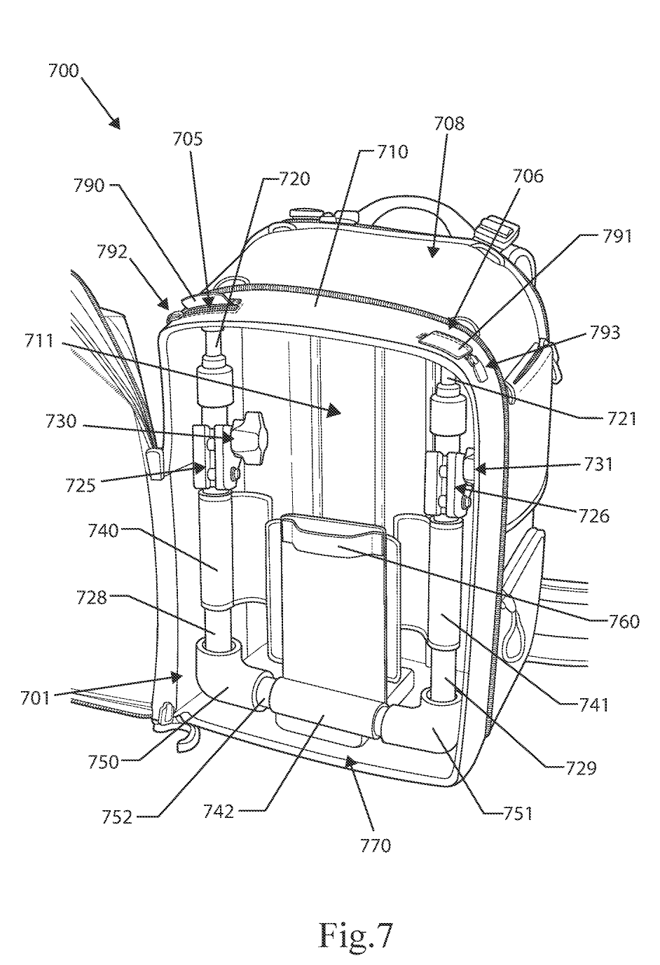

FIG. 7 is an illustration of a front view of another embodiment of a backpack with an integrated lighting mount apparatus with the lighting mount apparatus compartment exposed, and the mounting rods retracted and entirely enclosed within the backpack. As shown in FIG. 7, backpack 700 may comprise mounting rod openings 705, 706, lighting mount apparatus compartment 710, which has interior 711, which, in this embodiment, entirely contains integrated lighting mount apparatus 701, which comprises mounting rods 720, 721, vertical rods 728, 729, corner connectors 750, 751, base rod 752, vertical rod securing devices 740, 741, base rod securing device 742, adjustable connectors 725, 726, release mechanisms 730, 731, and counterweight 770. FIG. 2 shows mounting rods 720, 721 as retracted into vertical rods 220, 221, such that the profile and visibility of integrated lighting mount apparatus 701 is entirely hidden within backpack 100, which appears substantially similar to a normal backpack or camera backpack.

FIG. 7 shows that mounting rod openings 705, 706 may be closable and openable via closures 792, 793, which are shown as zippers, but may be any reopenable closure, such as a button, hook and loop, plastic zipper, friction snap, button, and the like. FIG. 7 also shows that mounting rod openings 705, 706 may have hiding flaps 790, 791, which may partially, substantially, or entirely conceal closures 792, 793. When the user wants to extend mounting rods 720, 721 through mounting rod openings 705, 706, the user opens closures 792, 793 and extends mounting rods 720, 721.

As shown, preferably, vertical rods 728, 729, and base rod 752 are connected via corner connectors 750, 751 such that they form a “U” or a rectangular shape, and vertical rods 728, 729 are balanced on opposite sides of interior 711 of lighting mount apparatus compartment 710. As shown in FIG. 7, a top end of vertical rods 728, 729 has adjustable connectors 725, 726, which are shown as friction clamps that are loosened or tightened, and which include release mechanisms 730, 731, which are shown as twist screws. When twist screw release mechanisms 730, 731 are loosened, mounting rods 720, 721 are configured to be extendible, in this case slidably or telescopically moveable in and out of vertical rods 728, 729. When twist screw release mechanisms 730, 731 are tightened, mounting rods 720, 721 are configured to be held firmly in place in whatever position a user put them in, such as retracted, partially extended, or entirely extended. In this manner, a user may adjust the height of each mounting rod, as desired. Adjustable connectors 725, 726, release mechanisms 730, 731 combine to provide two telescoping pole locks.

FIG. 7 also shows equipment loop 760, which may be used to securely, safely, and/or removeably hold equipment between vertical rods 728, 729. There may be additional straps, compartments, pockets, or netting to store various devices and equipment in lighting mount apparatus compartment 710 along with integrated lighting mount apparatus 701.

Counterweight 770 may be a removeable or adjustable device or weight that can be included in order to provide downward balance to backpack 700 when mounting rods 720, 721 are extended and supporting the weight of lighting equipment. Counterweight 770 may be connected to interior 711, to integrated lighting mount apparatus 701, and/or to base rod securing device 742.

Although integrated lighting mount apparatus 701 is shown as comprised of several different rods and connectors that are contained within lighting mount apparatus compartment 710, integrated lighting mount apparatus 701 may be a unitary rod that is bent in substantially the same shape as shown in FIG. 7. Preferably this unitary rod would have one or more extendible mounting rods and adjustable connectors. The extension may be telescopic, articulating, foldable, retractable, rollable, and the like.

FIG. 7 shows that integrated lighting mount apparatus 201 may be integrated with backpack 700 via vertical rod securing devices 740, 741 and base rod securing device 742. As shown, vertical rod securing devices 740, 741 and base rod securing device 742 may loop around vertical rods 728, 729, and base rod 752, thus securing vertical rods 728, 729, and base rod 252 to interior 711 of lighting mount apparatus compartment 710. In some embodiments, vertical rod securing devices 740, 741 and base rod securing device 742 may permanently secure integrated lighting mount apparatus 701 to interior 711 of lighting mount apparatus compartment 710. In other embodiments, vertical rod securing devices 740, 741 and base rod securing device 742 may removeably secure integrated lighting mount apparatus 701 to interior 711 of lighting mount apparatus compartment 710. As shown, vertical rod securing devices 740, 741 and base rod securing device 742 may be fabric reinforced with elastic (similar to a standard car seatbelt). In addition to being fabric, reinforced fabric, elastic, and/or leather straps, rod securing devices 740, 741 and base rod securing device 742 may be any securing device, such as clamps, clips, or an adhesive, so long as integrated lighting mount apparatus 701 is securely and integrally held in place within lighting mount apparatus compartment 710. Alternatively, integrated lighting mount apparatus 701 may be sewn directly into interior 711 of lighting mount apparatus compartment 710. Rod securing devices 740, 241 and base rod securing device 742 securely hold integrated lighting mount apparatus 701 when mounting rods 720, 721 are extended and have lighting equipment mounted.

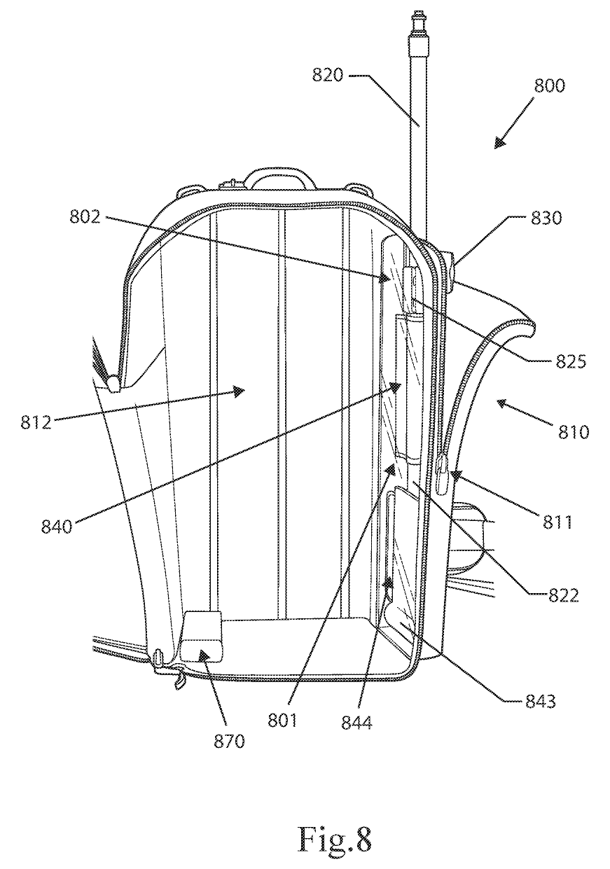

FIG. 8 is an illustration of a front view of another embodiment of a backpack with an integrated lighting mount apparatus with the lighting mount apparatus compartment exposed, and the mounting rod is at least partially extended from a side pocket of the backpack. As shown in FIG. 8, backpack 800 may comprise side pocket 810, which has integrated lighting mount apparatus 801, and front pocket 812. As shown, side pocket 810 and front pocket 812 may be separated by partition 802, which is shown as transparent for purposes of being able to view integrated lighting mount apparatus 801. In other embodiments, partition 802 is not transparent. As shown, integrated lighting mount apparatus 801 may comprise mounting rod 820, rod b, one or more rod securing devices 840, 843, 844, adjustable connector 825, release mechanism 830. FIG. 8 shows that integrated lighting mount apparatus 801 may have a single telescoping pole that is integrated within side pocket 810. The user may access integrated lighting mount apparatus 801 by opening closure 8 integrated lighting mount apparatus 801 or by another opening in side pocket 810, which may be a mounting rod opening. Rod 822 may be one or more rods, such as a bottom rod, base rod, and/or vertical rod, and may be secured, permanently or removeably, in an interior of side pocket 810 via one or more rod securing devices 843 (which may secure a base or bottom rod), 840, 844 (which may secure a vertical rod). As shown, counterweight 870, which may be located on an opposite side of backpack 800, may act to balance integrated lighting mount apparatus 801, which is integrated into side pocket 810. Although counterweight 870 is shown in front pocket 812, it may be in another side pocket or any other location on backpack 800. Counterweight 870 is most effective when it is opposite integrated lighting mount apparatus 801.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A backpack with an integrated lighting mount apparatus comprising:
a backpack comprising:
at least one integrated lighting mount apparatus compartment, which comprises two mounting rod openings;
a main storage compartment; and
an integrated lighting mount apparatus, wherein said integrated lighting mount apparatus comprises:
two sets of extending rods, each of which comprises a vertical rod, a mounting rod, and an adjustable connector;
wherein each of said two mounting rods is configured to extend through one of said two mounting rod openings;
wherein each of said two vertical rods is securely affixed to an interior of said integrated lighting mount apparatus compartment;
wherein each of said two mounting rods has a lighting equipment connector, which is configured to removeably and matingly engage with a piece of lighting equipment; and
wherein said at least one adjustable connector is configured to securely but releaseably lock said vertical rod and at least one mounting rod into a retracted position, an extended position, and one or more partially extended positions.

2. The backpack with an integrated lighting mount apparatus of claim 1, further comprising:
two shoulder straps;
one or more additional storage compartments; and
a hip belt.

3. The backpack with an integrated lighting mount apparatus of claim 1, wherein each of said at least one adjustable connectors has a release mechanism that when closed prevents said vertical rod and said mounting rod from moving in an extending manner with respect to each other, and that when open allows said vertical rod and said mounting rod to move in an extending manner with respect to each other.

4. The backpack with an integrated lighting mount apparatus of claim 1, wherein said integrated lighting mount apparatus compartment further comprises an equipment loop; and
wherein said integrated lighting mount apparatus further comprises a counterweight.

5. The backpack with an integrated lighting mount apparatus of claim 1, wherein said two vertical rods are connected to each other as a unitary base device.

6. The backpack with an integrated lighting mount apparatus of claim 5, wherein said unitary base device is substantially a rectangular “U” shape.

7. The backpack with an integrated lighting mount apparatus of claim 5, wherein said unitary base device is substantially a “V” shape.

8. The backpack with an integrated lighting mount apparatus of claim 1, wherein said integrated lighting mount apparatus further comprises two corner connectors and a base rod;
wherein said base rod is securely affixed to an interior of said integrated lighting mount apparatus compartment;
wherein each of said two corner connectors attaches to opposite sides of said base rod on one end and to one of said two vertical rods on the other end, such that said integrated lighting mount apparatus substantially forms a rectangular “U” shape.

9. The backpack with an integrated lighting mount apparatus of claim 8, wherein said two vertical rods of said integrated lighting mount apparatus are substantially parallel to each other and substantially perpendicular to said base rod;
wherein said base rod is secured by a base rod securing device; and
wherein said two vertical rods are secured by a rod securing device.

10. The backpack with an integrated lighting mount apparatus of claim 9, wherein said two vertical rods, said base rod, said two corner connectors, said two rod securing devices, and said base rod securing device, and said two adjustable connectors are substantially contained and enclosed within said integrated lighting mount apparatus compartment when said integrated lighting mount apparatus compartment is closed.

11. The backpack with an integrated lighting mount apparatus of claim 10, wherein said two mounting rods are substantially contained and enclosed within said integrated lighting mount apparatus compartment when said integrated lighting mount apparatus compartment is closed.

12. A backpack with an integrated lighting mount apparatus comprising:
a backpack comprising:
at least one integrated lighting mount apparatus compartment, which comprises at least one mounting rod opening;
one or more additional storage compartments;
at least one shoulder strap; and
an integrated lighting mount apparatus, wherein said integrated lighting mount apparatus comprises:
at least one set of extending rods, each of which has at least one adjustable connector;
wherein each set of said at least one set of extending rods comprises a vertical rod and at least one mounting rod;
wherein said at least one mounting rod is configured to extend through said at least one mounting rod opening;
wherein each vertical rod is securely affixed to an interior of said integrated lighting mount apparatus compartment by a rod securing device;
wherein said at least one mounting rod has a lighting equipment connector, which is configured to removeably and matingly engage with a piece of lighting equipment; and
wherein said at least one adjustable connector is configured to securely but releaseably lock said vertical rod and at least one mounting rod into a retracted position, an extended position, and one or more partially extended positions.

13. The backpack with an integrated lighting mount apparatus of claim 12, wherein said one or more additional storage compartments comprises a main storage compartment and one or more side pockets; and
wherein said backpack further comprises a hip belt.

14. The backpack with an integrated lighting mount apparatus of claim 12, wherein each of said at least one adjustable connectors has a release mechanism that when closed prevents said vertical rod from moving in an extending manner with respect to said mounting rod, and that when open allows said vertical rod to move in an extending manner with respect to said mounting rod.

15. The backpack with an integrated lighting mount apparatus of claim 12, wherein said integrated lighting mount apparatus compartment further comprises an equipment loop and wherein said integrated lighting mount apparatus further comprises a counterweight.

16. The backpack with an integrated lighting mount apparatus of claim 12, wherein there are two sets of extending rods and wherein said integrated lighting mount apparatus further comprises two conner connectors and a base rod, which is securely affixed to an interior of said integrated lighting mount apparatus compartment by a base rod securing device;
wherein each of said two corner connectors attaches to opposite sides of said base rod on one end and to one of said two vertical rods on the other end, such that said integrated lighting mount apparatus substantially forms a rectangular “U” shape.

17. The backpack with an integrated lighting mount apparatus of claim 16, wherein said two vertical rods of said integrated lighting mount apparatus are substantially parallel to each other and substantially perpendicular to said base rod.

18. The backpack with an integrated lighting mount apparatus of claim 16, wherein said two vertical rods, said base rod, said two corner connectors, said two rod securing devices, and said base rod securing device, and said two adjustable connectors are substantially contained and enclosed within said integrated lighting mount apparatus compartment when said integrated lighting mount apparatus compartment is closed.

19. A backpack with an integrated lighting mount apparatus comprising:
a backpack comprising:
an integrated lighting mount apparatus compartment, which comprises two mounting rod openings;
a main storage compartment;
two shoulder straps; and
an integrated lighting mount apparatus that comprises a “V” shaped rod that has two diagonally vertical ends, two mounting rods, and two adjustable connectors;
wherein each of said two diagonally vertical ends extendingly and matingly engage with one of said two mounting rods;
wherein each of said two mounting rods is configured to extend through one of said two mounting rod openings;
wherein said integrated lighting mount apparatus is securely affixed to an interior of said integrated lighting mount apparatus compartment by one or more securing devices;
wherein each of said two mounting rods has a lighting equipment connector, which is configured to removeably and matingly engage with a piece of lighting equipment; and
wherein each of said two adjustable connectors is configured to securely but releaseably lock one of said two diagonally vertical ends and one of said two mounting rods into a retracted position, an extended position, and one or more partially extended positions.

20. A backpack with an integrated lighting mount apparatus of claim 19, wherein said “V” shaped rod is constructed from an aluminum pole that has been bent into said “V” shape.
